(19) United States
(12) Patent Application Publication
(10) Pub. No.: US 2010/0047564 A1
(43) Pub. Date: Feb. 25, 2010

(54) CARBON NANOTUBE COMPOSITES

(75) Inventors: Yong Hyup Kim, Seoul (KR); Tae June Kang, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: SNU R&DB Foundation, Seoul (KR)

(21) Appl. No.: 12/194,413

(22) Filed: Aug. 19, 2008

(51) Int. Cl. B32B 15/04; B05D 7/14; B32B 15/02; C09D 5/44; C23C 28/00

(52) U.S. Cl. 428/336; 428/408; 427/405; 428/367; 204/492; 205/183

(57) ABSTRACT

Composites comprising carbon nanotubes are provided. In some embodiments, the composite may include at least one metal/carbon nanotube layer disposed between at least two metal layers, where the metal/carbon nanotube layer includes metal and a plurality of carbon nanotubes distributed in selected regions of the metal. In other embodiments, the composite may include a carbon nanotube rope and at least one metal layer disposed on an outer surface of the carbon nanotube rope.

### BACKGROUND

In recent years, various composite materials having a high degree of thermal stability have been developed for electronic, mechanical, and aerospace applications. Properties of low thermal strain and/or low thermal coefficient of resistance (TCR) are particularly important for a composite, especially when the performance of a device including the composite is easily affected by thermal noise, e.g., in electric wires, electrical lines of printed circuit boards, boiler and heat exchangers, aerospace and automotive components, building materials, and nuclear and power plant equipment. For example, the thermomechanical stability of a device in an aerospace application should be assured for a reliable operation under extremely severe temperature conditions in space. Also, the thermoelectronic stability of an electronic device should be guaranteed for a normal operation of the device under temperature variations which typically occur during operation. Low specific density and high elastic stiffness and strength are other physical properties that may be desirable in some applications.

Due to their extraordinary properties, carbon nanotubes (CNTs) have great potential for improving the mechanical, thermal, and electrical properties of composites. Their unique nanoscale configurations, such as the one-dimensional and high-aspect-ratio geometry, have inspired researchers to use CNTs as fillers of composite materials. Moreover, it is well known that CNTs have semiconducting properties with a negative thermal expansion coefficient and a negative TCR within a certain range of temperatures.

On the other hand, metals or metal-based composites have useful physical properties, such as good thermal or electrical conductivity and relatively high strength and stiffness, but generally exhibit a positive thermal expansion coefficient and high electrical resistance as the temperature increases.

### SUMMARY

Various embodiments of carbon nanotube (CNT) composites are disclosed herein. In one embodiment by way of non-limiting example, a composite comprises at least one metal/carbon nanotube layer disposed between at least two metal layers, where the metal/carbon nanotube layer includes metal and a plurality of carbon nanotubes distributed in selected regions of the metal.

In another embodiment, a method of making a composite comprises immersing a patterned metal layer into a colloidal solution having carbon nanotubes, withdrawing the patterned metal layer from the colloidal solution having carbon nanotubes under conditions effective to coat the carbon nanotubes onto selected regions of the metal layer, and depositing metal on the carbon nanotube-coated metal layer.

Embodiments of composites comprising a carbon nanotube rope are also disclosed herein. In one embodiment by way of non-limiting example, a composite comprises a carbon nanotube rope and at least one metal layer disposed on an outer surface of the carbon nanotube rope.

This Summary is provided to introduce a selection of concepts in a simplified form that are further described below in the Detailed Description. This Summary is not intended to identify key features or essential features of the claimed subject matter, nor is it intended to be used limit the scope of the claimed subject matter.

### BRIEF DESCRIPTION OF THE DRAWINGS

FIG. 1 is a schematic diagram showing a perspective view of an illustrative embodiment of a composite.

FIG. 2 is a schematic diagram showing a sectional front view of an illustrative embodiment of the composite shown in FIG. 1.

FIGS. 3A-F show several illustrative examples of a metal/carbon nanotube layer in a composite having a predetermined pattern of carbon nanotubes.

FIG. 4 is a schematic diagram showing an illustrative embodiment of a composite.

FIG. 5 is a schematic diagram showing another illustrative embodiment of a composite.

FIG. 6 is a schematic diagram showing still another illustrative embodiment of a composite.

FIGS. 7A-C are schematic diagrams showing an illustrative embodiment of a method for making a composite.

FIG. 8 is a schematic diagram showing a perspective view of an illustrative embodiment of a composite comprising a CNT rope.

FIG. 9 is a schematic diagram showing a perspective view of another illustrative embodiment of a composite comprising a CNT rope.

FIG. 10 is a schematic diagram showing a perspective view of still another illustrative embodiment of a composite comprising a CNT rope.

FIG. 11 is a schematic diagram showing a cross section of an illustrative embodiment of a composite comprising a CNT rope.

### DETAILED DESCRIPTION

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the components of the present disclosure, as generally described herein, and illustrated in the Figures, may be arranged, substituted, combined, and designed in a wide variety of different configurations, all of which are explicitly contemplated and make part of this disclosure. Those of ordinary skill will appreciate that, for the methods disclosed herein, the functions performed in the methods may be implemented in differing order. Furthermore, the outlined steps are provided only as examples, and some of the steps may be optional, combined into fewer steps, or expanded to include additional steps without detracting from the essence of the present disclosure.

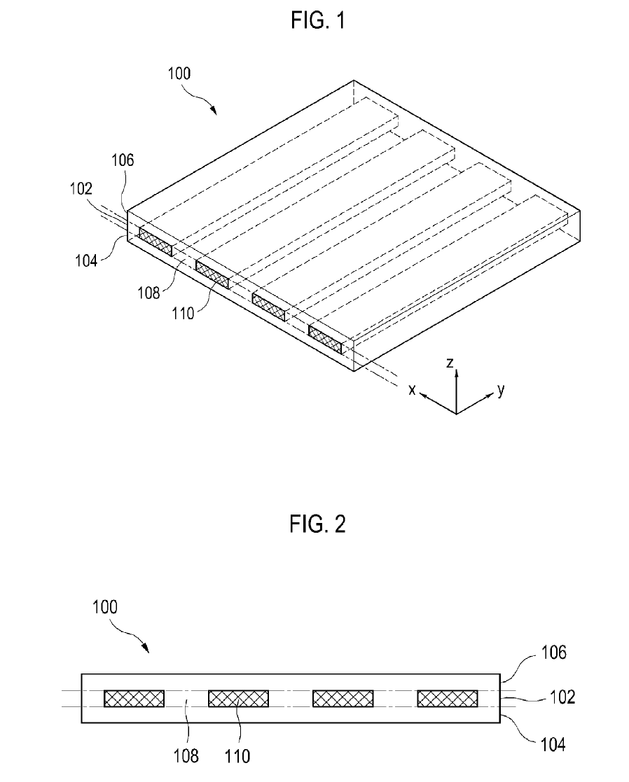

Referring to FIG. 1, a perspective view of an illustrative embodiment of a composite 100 is shown. The composite 100 comprises at least one metal/carbon nanotube (CNT) layer 102 disposed between at least two metal layers, 104, 106. The metal/CNT layer 102 includes a metal 108 and a plurality of CNTs 110 distributed in selected regions of the metal. In the present disclosure, the term “layer” does not always imply the existence of a physical interface between any two layers, e.g., an interface created from a difference in composition of the layers.

In some embodiments, the plurality of CNTs 110 in the metal/CNT layer 102 of the composite may be distributed to form at least one domain which extends substantially throughout the entire thickness of the metal/CNT layer 102, as shown in FIG. 2. FIG. 2 is a schematic diagram showing a sectional front view of an illustrative embodiment of the composite shown in FIG. 1.

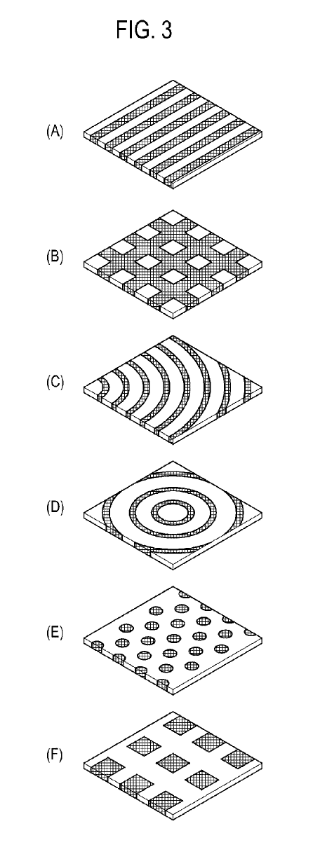

In some embodiments, the plurality of CNTs in the metal/CNT layer of the composite may be configured in a predetermined pattern. The predetermined patterns may have various shapes including, but not limited to, straight bands, curved bands, circular shapes, elliptical shapes, polygonal shapes, and irregular shapes, as illustrated in FIGS. 3A-F. The CNTs in the metal/CNT layer may include single-walled nanotubes (SWNTs), multi-walled nanotubes (MWNTs), or any combination thereof The CNTs in the metal/CNT layer may be randomly oriented within the predetermined pattern or, depending on the pattern, may be oriented in a substantially identical direction.

In some embodiments, the thickness of the metal/CNT layer in the composite may range from about 1 nm to about 10 mm.

Referring back to FIG. 1, suitable metals for the at least two metal layers 104, 106, as well as the metal 108 in the metal/CNT layer 102, may include, but are not limited to, any type of metal used for mechanical, thermal, or electrical applications, e.g., Cu, Al, Au, Ag, Pt, Ti, Mn, W, Zn, Co, Cr, Ni, or any combination thereof. In some embodiments, the metals for the at least two metal layers 104, 106 and the metal 108 in the metal/CNT layer 102 may be of the same type. In other embodiments, the metals for the at least two metal layers 104, 106 may be different from the metal 108 in the metal/CNT layer 102. In some embodiments, the thickness of the metal layer in the composite may range from about 1 nm to about 10 mm.

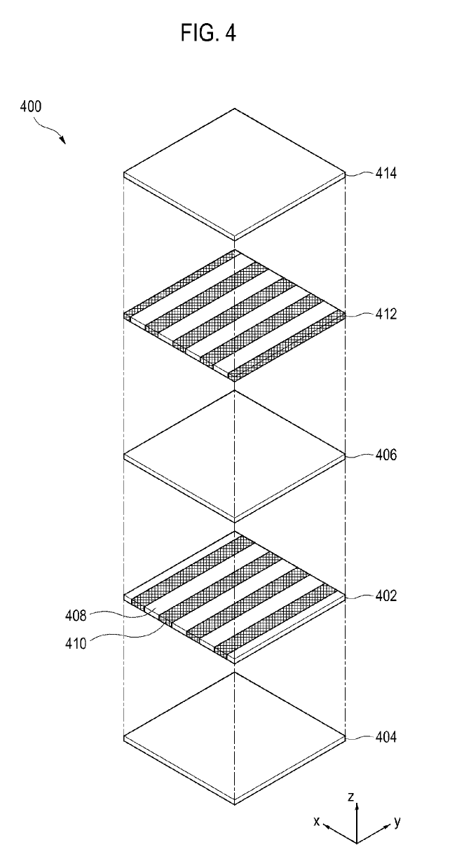

In some embodiments, the composite may include a plurality of metal/CNT layers and a plurality of metal layers, where the metal/CNT layers and metal layers are alternately arranged. For example, FIG. 4 shows a schematic of an illustrative embodiment of a composite 400 having five layers in total. The composite 400 may include a metal/CNT layer 402 disposed between two metal layers, 404, 406, where the metal/CNT layer 402 includes metal 408 and a plurality of CNTs 410 distributed in selected regions of the metal 408. The composite 400 may further include an additional metal/CNT layer 412 and an additional metal layer 414.

In some embodiments, each of the plurality of metal/CNT layers may have the same or similar predetermined pattern of CNTs, as in the embodiment shown in FIG. 4 where both metal/CNT layers 402, 412 have the same straight band patterns of CNTs. In some embodiments, more than one of the plurality of metal/CNT layers may have predetermined patterns of CNTs that are different from one another.

In some embodiments, more than one of the plurality of metal/CNT layers may have CNT patterns oriented in a substantially identical in-plane direction, as in the embodiment shown in FIG. 4.

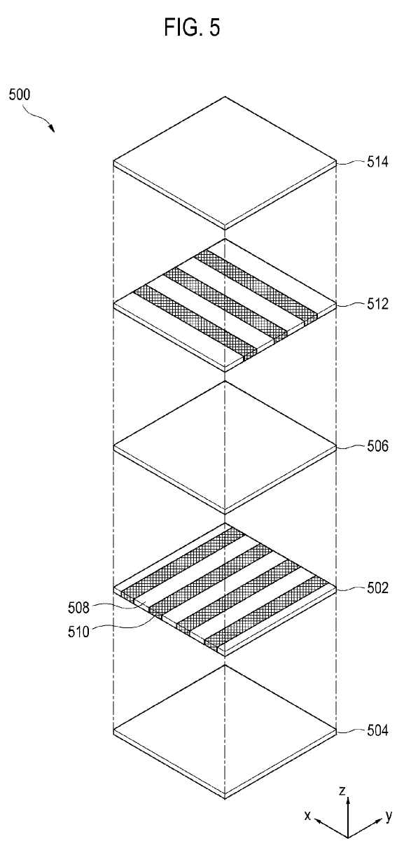

In other embodiments, at least one of the plurality of metal/CNT layers may have a CNT pattern oriented at one in-plane direction and another metal/CNT layer may have a CNT pattern oriented at another in-plane direction that is at an angle with the one in-plane direction, as in the embodiment shown in FIG. 5. FIG. 5 shows an illustrative embodiment of a composite 500 having five layers in total. The composite 500 may include a metal/CNT layer 502 disposed between two metal layers, 504, 506, where the metal/CNT layer 502 includes metal 508 and a plurality of CNTs 510 distributed in selected regions of the metal 508. The composite 500 may further include an additional metal/CNT layer 512 and an additional metal layer 514. FIG. 5 shows an illustrative embodiment where the CNT pattern in the metal/CNT layer 512 is oriented at an in-plane direction that is at a 90° angle with the in-plane direction at which the CNT pattern in the metal/CNT layer 502 is oriented. It will be appreciated that the above illustrative embodiment depicted in FIG. 5, where CNT patterns are at a 90° angle with another CNT pattern from another metal/CNT layer is only being disclosed for exemplary purposes and is not meant to be limiting in any way. In other words, a CNT pattern from one metal/CNT layer may be oriented at an in-plane direction that is at varying angles with another CNT pattern from another metal/CNT layer.

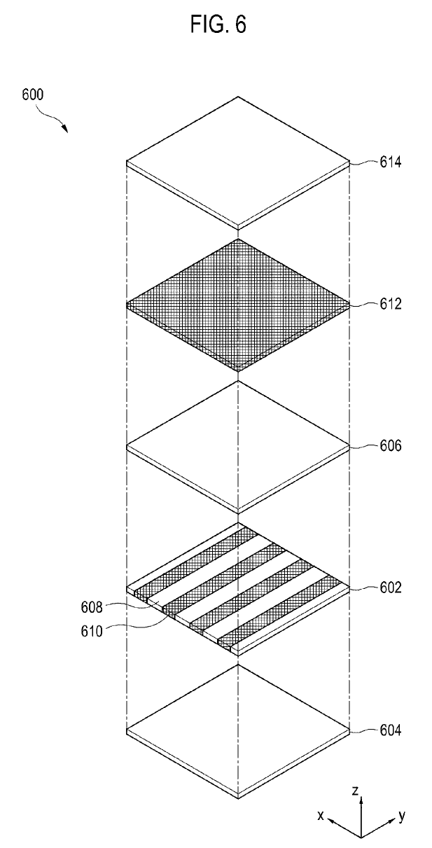

Referring to FIG. 6, another illustrative embodiment of a composite 600 is shown, where the composite 600 further includes at least one CNT layer disposed between two of the plurality of metal layers. Thus, the composite 600 may include, in addition to a metal/CNT layer 602 disposed between two metal layers, 604, 606 where the metal/CNT layer 602 includes metal 608 and a plurality of CNTs 610 distributed in selected regions of the metal 608, a CNT layer 612 and an additional metal layer 614. Suitable metals for the metal layers 604, 606, 614 and the metal 608 in the metal/CNT layer 602 are as described above. Suitable CNTs for the metal/CNT layer 602 and the at least one CNT layer 612 are also described above.

The composites described in accordance with the illustrative embodiments disclosed herein may have different properties or exhibit different performances depending on the characteristics of the metal layer, metal/CNT layer, and CNT layer, e.g., pattern shape, arrangement, volume or density of the CNT regions, and the disposition of the metal layer, metal/CNT layer, and CNT layer. For example, the composites illustrated in FIGS. 1 and 4 may have a decreased thermal strain, i.e., have a thermal expansion coefficient near zero, in the y direction than in the x direction, since the CNT regions are patterned along the y axis, in which the CNT regions may be more capable of compensating the thermal expansion of the metal layers. Further, the composites illustrated in FIGS. 1 and 4 may have a zero or near zero TCR in the y direction than in the x or z direction. In another example, the composite illustrated in FIG. 5 may have decreased thermal strain in both x and y directions, since the two metal/CNT layers 502 and 512 may be capable of offsetting the thermal expansions of the metal layers along the y and x directions, respectively Further, the composite illustrated in FIG. 5 may have a zero or near zero TCR in both x and y directions. In yet another example, the composite illustrated in FIG. 6 may exhibit different thermal strain and TCR along the z direction, in addition to the x and y directions. It may also be possible to modify properties of the composite, such as thermal strain or TCR, along the z direction by layering different metal/CNT layers that have CNT patterns at various angles from one another. The thermomechanical and thermoelectrical properties of the metal-CNT composites may be controlled based on the principle of the rule of mixture.

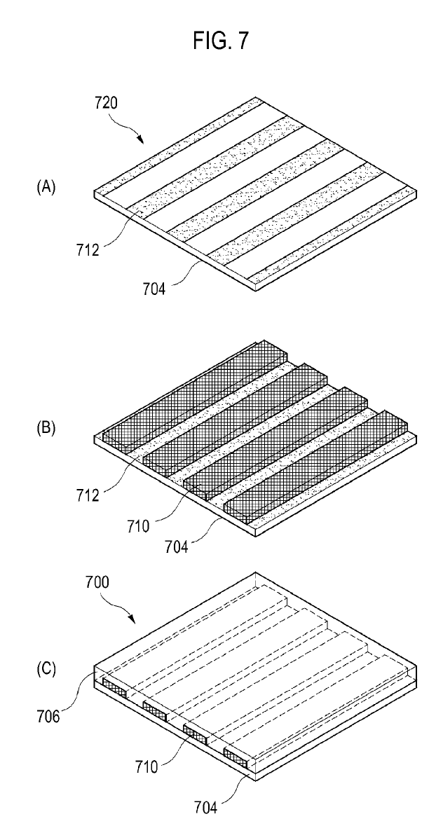

Referring to FIGS. 7A-C, schematic diagrams showing an illustrative embodiment of a method for making a composite 700 is shown. First, a patterned metal layer 720 having a pattern 712 formed on a metal layer 704 is provided, as shown in FIG. 7A. Next, the patterned metal layer 720 is immersed into a CNT colloidal solution and then withdrawn to coat CNTs 710 onto selected surface regions of the metal layer 704 unmasked by the pattern 712, as shown in FIG. 7B. Then, metal 706 is deposited on the metal layer 704 coated with CNTs 710 to form the composite 700, as shown in FIG. 7C.

The above steps may be repeatedly carried out to make a composite including a plurality of metal/CNT layers and a plurality of metal layers, where the metal/CNT layers and metal layers are alternately arranged.

In some embodiments, the above method may further involve forming the pattern 712 on the metal layer 704, prior to immersing the patterned metal layer 720 into a CNT colloidal solution. In some embodiments, the pattern 712 may be formed on the metal layer 704 by using photoresist material to form a topographical template and mask portions of the metal layer 704 to be coated with CNTs. Photoresist is hydrophobic, which is in contrast to the hydrophilicity of a metal layer, e.g., copper. This difference in the hydration property between the photoresist and the metal layer may be used to coat selected regions of the metal layer 704 with CNTs 710. In some embodiments, after the CNTs 710 are coated onto selected regions of the metal layer 704 unmasked by the pattern 712, the pattern 712 may be removed.

In some embodiments, a pattern may be formed on a metal layer by using self-assembled monolayers (SAMs) that have differing affinities to CNTs. For example, hydrophobic SAMs, such as octadecyltrichlorosilane, may be applied to selected regions of a metal layer to prevent the adhesion of CNTs to the metal layer, whereas hydrophilic SAMs, such as 16-mercaptohexadecanoic acid and aminoethanethiol, may be applied to selected regions of a metal layer to enhance the adhesion of CNTs.

The metal layers may include a metal selected from the group consisting of Cu, Al, Au, Ag, Pt, Ti, Mn, W, Zn, Co, Cr, Ni, and any combination thereof.

A homogeneous distribution of CNTs within the in-plane direction of the composite may be obtained by carrying out dip-coating of a patterned metal layer using a dispersive colloidal solution containing CNTs. Dip-coating technique is a process where the substrate to be coated is immersed in a liquid and then withdrawn with a well-defined withdrawal speed under controlled temperature and atmospheric conditions. Since CNTs generally form aggregates due to the very strong van der Waals interactions, a stable dispersive CNT colloidal solution may be used for a uniform dip-coating of CNTs onto the patterned metal layer. To prepare stable aqueous dispersions of CNTs, the electrostatic repulsion forces should overcome the van der Waals forces between the CNTs with their zeta potentials. While oxidized CNTs allow the preparation of metastable dispersions in deionized water without additional surfactant due to the presence of carboxylic acid groups, the degree of dispersion is insufficient to obtain uniformity in a dip-coating of CNTs. Therefore, an anionic surfactant, such as sodium dodecyl sulfate (SDS), may be included in the CNT colloidal solution to obtain a stable colloidal solution, where the CNTs are chemically functionalized with SDS in the aqueous solution. SDS contains a hydrophilic sulfate segment and a hydrophobic hydrocarbon segment and interacts with CNTs through its hydrophobic segment. Thus, the SDS functionalized CNTs have a hydrophilic surface with negative charges, where the hydrophilic CNTs deposit only on hydrophilic surfaces, not on hydrophobic surfaces. This selectivity of CNTs toward hydrophilic surfaces enables the fabrication of metal layers patterned with CNTs. The CNT colloidal solution may include SWNTs, MWNTs, or any combination thereof

In some embodiments, metal may be deposited on the CNT-coated metal layer by electroplating, using an electrolyte containing metal ions. Wet-based electroplating allows the metal particles to fill into the nanoscale gaps between CNTs, enhancing the mechanical strength and electrical conductivity of the composite due to the metal-bridging effect. In some embodiments, metal may be deposited on the CNT-coated metal layer by a physical vapor deposition (PVD) method, such as sputtering, E-beam evaporation, thermal evaporation, laser molecular beam epitaxy, and pulsed laser deposition. In some embodiments, a combination of electroplating and PVD may be used to deposit the metal on the CNT-coated metal layer.

In some embodiments, the same metal as the metal in the patterned metal layer may be deposited on the CNT-coated metal layer. In such a case, a distinct physical interface may not exist between the metal layers and the metal/CNT layers, since the metal in the respective layers may form a unified metal structure. In some embodiments, a different metal from the metal in the patterned metal layer may be deposited on the CNT-coated metal layer, where a distinct physical interface may exist between the metal layers and the metal/CNT layers.

The volume or density of the metal/CNT layer may be adjusted as required by controlling the conditions of the CNT coating process. For example, repeating the immersing and drying steps during the selective-dip coating process may increase the thickness of the metal/CNT layer, thereby increasing the volume of the layer. The thickness or volume of the metal/CNT layer may also be adjusted by controlling the concentration of the CNT colloidal solution and/or controlling the withdrawal velocity of the immersed metal layer. For example, if the colloidal solution used in the selective dip-coating process has a higher CNT concentration, the resulting metal/CNT layer may have an increased CNT density. In addition, if the withdrawal velocity increases, the thickness of the metal/CNT layer may decrease, while a delayed withdrawal time, i.e., decreased withdrawal velocity, may increase the thickness of the metal/CNT layer. In some embodiments, the withdrawal velocity may be about 10 cm/min or less.

The volume or density of the metal layer may also be adjusted by controlling the conditions of the metal deposition process. For example, the volume of the metal layer may be increased if the reaction time during PVD or electroplating is extended. The density of the metal layer can also be adjusted by, for example, controlling the metal ion concentration of the electrolyte used in electroplating.

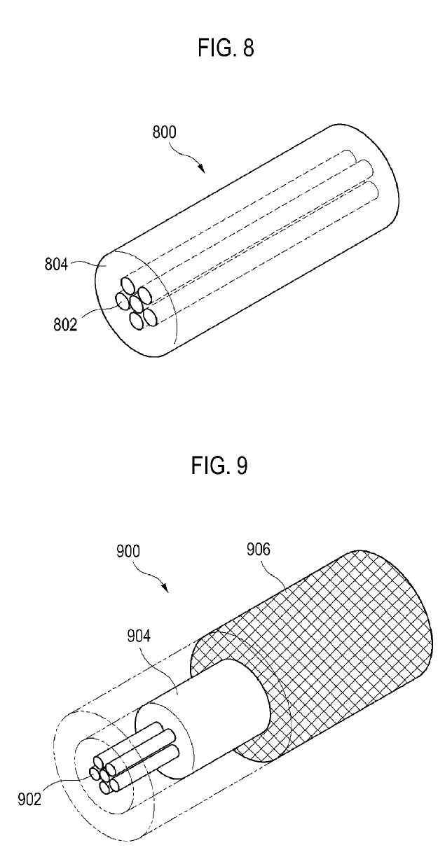

Further, a composite comprising a CNT rope and at least one metal layer disposed on an outer surface of the CNT rope, is provided. Referring to FIG. 8, a schematic diagram showing a perspective view of an illustrative embodiment of a composite 800 comprising a CNT rope is shown. The composite 800 may have a cylindrical shape, such as the shape of a coaxial cable, and may include a CNT rope 802 and at least one metal layer 804 disposed on an outer surface of the CNT rope 802. In some embodiments, the CNT rope 802 may include at least two strands of CNTs. The CNT strands may include CNTs selected from the group consisting of SWNTs, MWNTs, and a combination thereof The at least one metal layer 804 may be disposed on a portion of the outer surface of the CNT rope 802 or the entire CNT rope 802. In some embodiments, the at least one metal layer 804 may include a metal selected from any type of metal used for mechanical, thermal, or electrical applications, e.g., Cu, Al, Au, Ag, Pt, Ti, Mn, W, Zn, Co, Cr, Ni, and any combination thereof

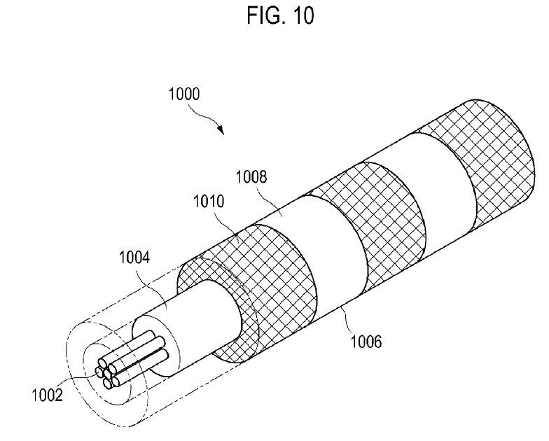

Referring to FIG. 9, a schematic diagram showing a perspective view of another illustrative embodiment of a composite 900 comprising a CNT rope is shown. The composite 900 may include a CNT rope 902, at least one metal layer 904 disposed on an outer surface of the CNT rope 902, and at least one CNT layer 906 disposed on the metal layer 904, where the CNTs are distributed on the entire metal layer 904 of the composite 900. In some embodiments, the CNTs may be distributed in selected regions of the metal layer, as illustrated in FIG. 10. FIG. 10 is a schematic diagram showing a perspective view of still another illustrative embodiment of a composite 1000 comprising a CNT rope, where the composite 1000 may include a CNT rope 1002, at least one metal layer 1004 disposed on an outer surface of the CNT rope 1002, and at least one metal/CNT layer 1006 disposed on the metal layer 1004. The metal/CNT layer 1006 includes metal 1008 and a plurality of CNTs 1010 distributed in selected regions of the metal 1008. The CNTs may be oriented randomly or in substantially the same direction.

In some embodiments, the thickness of the metal layer in the composite may range from about 1 nm to about 10 mm.

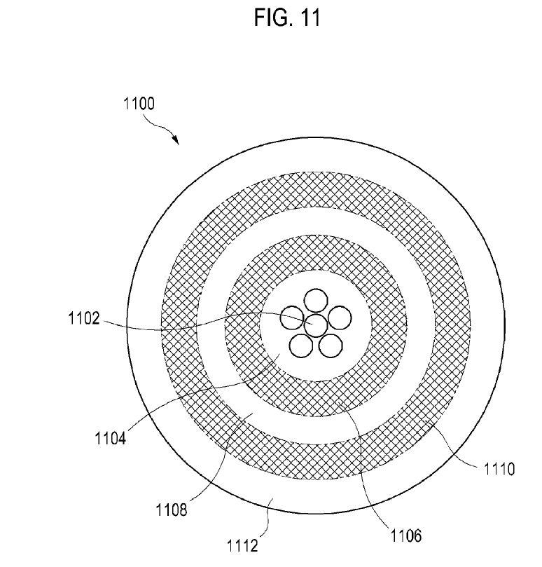

In some embodiments, the composite may include a plurality of metal layers and at least one CNT layer, where the metal layers and the CNT layer are alternately arranged along the radial direction of the composite. For example, FIG. 11 is a schematic diagram showing a cross-section of an illustrative embodiment of a composite 1100 comprising a CNT rope, where the composite 1100 may include a CNT rope 1102, a plurality of metal layers 1104, 1108, 1112 and at least one CNT layer 1106, 1110, where the metal layers 1104, 1108, 1112 and the CNT layers 1106, 1110 are alternately arranged. Other embodiments where a plurality of metal layers, CNT layers, and/or metal/CNT layers are alternately arranged on a CNT rope are also possible. In some embodiments, the thickness of the CNT layer or metal/CNT layer in the composite may range from about 1 nm to about 10 mm.

The metal layers may include a metal selected from the group consisting of Cu, Al, Au, Ag, Pt, Ti, Mn, W, Zn, Co, Cr, Ni, and any combination thereof The metals in the metal layer and the metal/CNT layer may be the same or different.

The CNTs in the CNT layers and the metal/CNT layers may be selected from the group consisting of SWNTs, MWNTs, and a combination thereof. The CNTs in the CNT layers and the metal/CNT layers may be randomly oriented, or a portion of or a substantially large portion of CNTs may be oriented in substantially the same direction.

The descriptions regarding the individual layers within the planar type composite and methods of preparing the composite, illustrated in FIGS. 1-7, also apply to the cable type composites, to the extent there are no limitations caused by the structural difference between the two different types of composites.

For manufacturing cable type composites, such as those illustrated in FIGS. 8-11, methods similar to those used for making the planar type composites may be employed. For example, metal layers may be deposited by using PVD or electroplating technique. Wet-based techniques like electroplating allow filling-up of the metal particles into nanoscale gaps between the CNTs, which enhances mechanical strength and electrical conductivity of the composite due to the metal-bridging effect and the ballistic transport of electrons in the CNT rope. Further, CNT layers may be coated by a suitable method, such as dip-coating, using a colloidal solution having CNTs. Similar to the above-described methods for making planar type composites, CNTs may be coated selectively on the metal layer by using photoresist material or SAMs that have differing affinities to CNTs.

Similar to the above-described methods for making planar type composites, the volume or density of CNTs or metal in the individual layers of the cable type composite can be adjusted as required by controlling the conditions of the CNT or metal coating process. Further, the cable type composite may have different properties by controlling the characteristics of the CNT rope, e.g., the volume and density of the CNT rope.

Furthermore, the cable type composite in accordance with the present disclosure may exhibit different performances depending on the characteristics of the metal and CNT layers (e.g., volume, density or disposition of the layers). For example, the composites illustrated in FIGS. 8-11 may have near zero thermal strain and near zero TCR in the axial direction depending on the volume ratio of the CNTs and metal.

The composites of the illustrative embodiments disclosed herein having thermal stability may be used in a variety of fields that demand enhanced mechanical, thermal, or electrical performance.

### EXAMPLES

The following examples are provided for illustration of some of the illustrative embodiments of the present disclosure but are by no means intended to limit their scope.

### Example 1

### Preparation of a Cu—Cu/CNT Laminated Composite

The CNT colloidal solution used for coating the CNTs onto the metal layer is prepared as follows. Multi-walled CNTs synthesized from catalytic decomposition of CH₄ with diameters of 3-5 nm and lengths of 10-20 μm are used, where pristine CNTs are purified by performing dry oxidation of CNTs, i.e., annealing at 450° C. for 80 min in air, to remove amorphous carbon and carbonaceous nanoparticles and removing the metal catalysts and catalyst supports by nitric acid boiling at 50° C. for 1 hr assisted by ultrasonication. SDS (sodium dodecyl sulfate, 288 g/mol) is utilized to prepare the stable colloidal solutions, where the purified CNTs are chemically functionalized with SDS in the aqueous dispersion with a concentration of 3.48 mM. The density of CNTs is concentrated to 0.1 mg/mL.

A copper substrate is provided and masked with a photoresist (AZ4620, commercially obtainable from AZ Electronic Materials Ltd.) pattern. The masked copper substrate is immersed vertically into the CNT colloidal solution for dip-coating and then withdrawn with a withdrawal velocity of 3 mm/min at room temperature, resulting in a substrate selectively coated with CNTs on the unmasked surface portions. The photoresist is removed from the substrate using acetone. A sulfuric acid bath (75 g/l of CuSO₄.5H₂O+180 g/L of H₂SO₄+70 mg/L of HCl) is prepared for base electroplating. Electroplating is performed with a current density of 10 mA/cm² at room temperature. The selective dip-coating and electroplating are alternately repeated to produce a Cu—Cu/CNT laminated composite structure.

### Example 2

### Preparation of a Ni-Laminated Composite Comprising CNT Rope

First, a CNT rope is prepared by chemical vapor deposition (CVD) method, using n-hexane as a precursor. Argon gas is flowed to the reaction chamber of the CVD apparatus at the rate of 100 mL/min while the temperature is increased. The argon gas is switched to flowing hydrogen gas, when the temperature reaches about 1000° C. After reaching a preset reaction temperature of 1100° C., the solution mixture of n-hexane, ferrocene (0.01 g/mL), and thiophene (0.6 wt %) is introduced into the reaction chamber to start the reaction. The flow rate of the solution is about 0.5 mL/min, while the flow rate of the hydrogen gas is about 200 ml/min. The reaction is conducted for about 60 minutes and then terminated by flowing argon gas at 100 mL/min instead of flowing hydrogen. The CNT products are collected after cooling the reaction chamber to room temperature, where SWNT bundles are produced.

The CNT ropes are rinsed in an acetone/distilled water (1:1 vol. ratio) solution by ultrasonication for 5 minutes. An additional rinse is carried out using a NH₄OH/H₂O solution (1:5 vol. ratio) at 80° C. for 5 minutes, followed by a rinse with distilled water. The CNT ropes are rinsed once more with a HCl/H₂) solution (1:6 vol. ratio) at 80° C. for 5 minutes, followed by a rinse with distilled water. The CNT ropes are sensitized by immersing the ropes in a 0.1 mol SnCl₂/0.1 mol HCl solution at 70° C. Then, the CNT ropes are activated by a 0.1 mol PdCl₂/0.2 mol EDTA/0.5 mol HF solution. The resulting CNT ropes are dispersed using an ultrasonic generator, and then electroplated in an electroplating bath containing nickel sulfate (0.12 mol/L), DMAB (0.5˜3.0 g/L), and sodium acetate (0.07 mol/L) at 90° C., wherein the pH is adjusted to 4.3 using a 10% H₂SO₄ solution.

Although the present disclosure has been described in detail with reference to certain embodiments thereof, other embodiments are possible. For example, metal/CNT and CNT layers may be coated on any material having a metal surface, such as a metal block or mechanical component, instead of a metal substrate. In addition, the cable type composite may include more than one CNT rope, if desired. Further, the composite may be formed into various shapes, for example cylindrical or polygonal columns.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A composite comprising:
at least one metal/carbon nanotube layer disposed between at least two metal layers, wherein the metal/carbon nanotube layer includes metal and a plurality of carbon nanotubes distributed in selected regions of the metal.

2. The composite of claim 1, wherein the composite includes a plurality of metal/carbon nanotube layers and a plurality of metal layers, the metal/carbon nanotube layers and metal layers being alternately arranged.

3. The composite of claim 1, wherein the carbon nanotubes in the metal/carbon nanotube layer are configured in a predetermined pattern.

4. The composite of claim 2, wherein each of the plurality of metal/carbon nanotube layers has the same predetermined pattern of carbon nanotubes.

5. The composite of claim 2, wherein more than one of the plurality of metal/carbon nanotube layers have predetermined patterns of carbon nanotubes that are different from one another.

6. The composite of claim 2, wherein more than one of the plurality of metal/carbon nanotube layers have carbon nanotube patterns oriented in a substantially identical in-plane direction.

7. The composite of claim 2, wherein at least one of the plurality of metal/carbon nanotube layers has a carbon nanotube pattern oriented at one in-plane direction and another metal/carbon nanotube layer has a carbon nanotube pattern oriented at another in-plane direction that is at an angle with the one in-plane direction.

8. The composite of claim 2, further comprising:
at least one carbon nanotube layer disposed between two of the plurality of metal layers.

9. The composite of claim 1, wherein the metal layer has a thickness ranging from about 1 nm to about 10 mm.

10. The composite of claim 1, wherein the metal/carbon nanotube layer has a thickness ranging from about 1 nm to about 10 mm.

11. The composite of claim 1, wherein the metal layer comprises a metal selected from the group consisting of Cu, Al, Au, Ag, Pt, Ti, Mn, W, Zn, Co, Cr, Ni, and any combination thereof.

12. The composite of claim 1, wherein the metal in the at least two metal layers and the metal in the metal/carbon nanotube layer are of the same type.

13. The composite of claim 1, wherein the carbon nanotubes in the metal/carbon nanotube layer are single-walled nanotubes, multi-walled nanotubes, or a combination thereof.

14. The composite of claim 1, wherein the composite has a thermal expansion coefficient of about zero and/or a thermal coefficient of resistance of about zero.

15. A method of making a composite comprising:
immersing a patterned metal layer into a colloidal solution having carbon nanotubes;
withdrawing the patterned metal layer from the colloidal solution having carbon nanotubes under conditions effective to coat the carbon nanotubes onto selected regions of the metal layer; and
depositing metal on the carbon nanotube-coated metal layer.

16. The method of claim 15, wherein the immersing, the withdrawing, and the depositing are repeatedly carried out to make a composite comprising a plurality of metal/carbon nanotube layers and a plurality of metal layers, wherein the metal/carbon nanotube layers and metal layers are alternately arranged.

17. The method of claim 15 further comprising:
forming a pattern on a metal layer, prior to the immersing.

18. The method of claim 17, wherein the pattern comprises photoresist material.

19. The method of claim 17, wherein the pattern comprises a self-assembled monolayer.

20. The method of claim 15, wherein the colloidal solution having carbon nanotubes comprises an anionic surfactant.

21. The method of claim 15, wherein the colloidal solution having carbon nanotubes comprise single-walled nanotubes, multi-walled nanotubes, or a combination thereof.

22. The method of claim 15, wherein the patterned metal layer is withdrawn from the colloidal solution having carbon nanotubes at a predetermined velocity.

23. The method of claim 22, wherein the predetermined velocity is about 10 cm/min or less.

24. The method of claim 15, wherein the depositing metal is carried out by electroplating or physical vapor deposition.

25. The method of claim 15, wherein the metal layer comprises a metal selected from the group consisting of Cu, Al, Au, Ag, Pt, Ti, Mn, W, Zn, Co, Cr, Ni, and any combination thereof.

26. The method of claim 15, wherein the composite has a thermal expansion coefficient of about zero and/or a thermal coefficient of resistance of about zero.

27. A composite comprising:
a carbon nanotube rope; and
at least one metal layer disposed on an outer surface of the carbon nanotube rope.

28. The composite of claim 27 further comprising:
at least one carbon nanotube layer or metal/carbon nanotube layer disposed on the at least one metal layer, wherein the metal/carbon nanotube layer includes metal and a plurality of carbon nanotubes distributed in selected regions of the metal.

29. The composite of claim 28, wherein the composite comprises a plurality of metal layers and at least one carbon nanotube layer, the metal layers and the carbon nanotube layer being alternately arranged.

30. The composite of claim 27, wherein the metal layer has a thickness ranging from about 1 nm to about 10 mm.

31. The composite of claim 28, wherein the carbon nanotube layer or metal/carbon nanotube layer has a thickness ranging from about 1 nm to about 10 mm.

32. The composite of claim 27, wherein the metal layer comprises a metal selected from the group consisting of Cu, Al, Au, Ag, Pt, Ti, Mn, W, Zn, Co, Cr, Ni, and any combination thereof.

33. The composite of claim 28, wherein the metal in the at least one metal/carbon nanotube layer and the metal in the at least one metal layer are of the same type.

34. The composite of claim 27, wherein the carbon nanotubes in the carbon nanotube rope are selected from the group consisting of single-walled nanotubes, multi-walled nanotubes, and a combination thereof.

35. The composite of claim 28, wherein the carbon nanotubes in the carbon nanotube layer or metal/carbon nanotube layer are selected from the group consisting of single-walled nanotubes, multi-walled nanotubes, and a combination thereof.

36. The composite of claim 27, wherein the composite has a thermal expansion coefficient of about zero and/or a thermal coefficient of resistance of about zero.
